(19) United States
(12) Patent Application Publication
(10) Pub. No.: US 2008/0212901 A1
(43) Pub. Date: Sep. 4, 2008

(54) System and Method for Correcting Low Confidence Characters From an OCR Engine With an HTML Web Form

(75) Inventors: Tom Castiglia, San Diego, CA (US); Mark Walter, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: H.B.P. OF SAN DIEGO, INC., La Jolla, CA (US)

(21) Appl. No.: 12/041,511

(22) Filed: Mar. 3, 2008

Related U.S. Application Data
(60) Provisional application No. 60/892,478, filed on Mar. 1, 2007.

(51) Int. Cl. G06K 9/03

(52) U.S. Cl. 382/311

(57) ABSTRACT

A character based system and method for correcting low confidence characters from an OCR system facilitates operator review, editing and correction of character and field level data generated by an OCR system without the need for an application that is installed at the operator workstation. The system creates a data structure of OCR information and provides that information to an operator through an HTML interface that is rendered using HTML and JavaScript. The data structure includes an OCR confidence level for each character and/or field and the operator is prompted to review only those characters/fields that meet a predetermined threshold for the confidence level. The operator can use an input key (e.g., TAB or ENTER) to navigate to each character/field with a low confidence level and thereby correct or validate each low confidence character/field as appropriate.

### RELATED APPLICATION

The present application claims priority to U.S. provisional patent application Ser. No. 60/892,478 filed on Mar. 1, 2007, which is incorporated herein by reference in its entirety.

### BACKGROUND

1. Field of the Invention

The present invention generally relates to optical character recognition and more particularly relates to correcting low confidence characters generated by an optical character recognition engine using a hypertext markup language (“HTML”) form.

2. Related Art

It is common for organizations to use a wide range of conventional optical character recognition (“OCR”) software utilities to read character and field level data from scanned images of structured and semi-structured forms. Data captured using OCR utilities on such forms may be hand printed or machine printed.

Because OCR engines are imperfect, field and character data captured using an OCR engine is generally reviewed by a human operator, who corrects any incorrect characters before the data is exported to a permanent system of record.

Many conventional OCR solutions provide a “thick client” user interface to enable operators to review and correct proposed data from the OCR engine. To streamline the manual review and correction process, these applications often highlight specific zones or characters flagged by the OCR engine as being read and converted to text with low confidence. These low confidence characters require special attention from a human operator for review and correction. Assuming that the OCR engine produces no false positive values, the operator only needs to review low confidence characters from the OCR engine.

While these conventional OCR utilities are common in the industry today, they are hampered by the necessary use of standard thick client user interfaces, which are typically applications that must be installed, configured, and maintained so that they can run under the Microsoft Windows (or other) operating system that is on the computer being used by the operator. These thick clients are required by the conventional OCR utilities so that an operator can be presented with highlighted zones or characters that have been flagged as requiring special attention from the operator. Accordingly, what is needed is a system and method for correcting low confidence characters generated by an OCR engine that avoids the drawbacks of a thick client user interface as required by the conventional solutions.

### SUMMARY

Accordingly, described herein is a system and method for correcting low confidence characters generated by an OCR engine that is implemented using client side hypertext markup language (“HTML”) and JavaScript within a standard web browser utility.

The system supports human review, editing and correction of character and field level data generated by an OCR engine within a browser-based web application, rendered with HTML and using JavaScript. The system captures results from an OCR engine, including the best guess value for each field, the confidence level for each character within each field, and the X/Y coordinate positions for each character and field from the source image document. The system stores this information in an extensible markup language (“XML”) form to allow the OCR editing interface to be decoupled from the OCR engine.

The web browser client presents the user with a form that appears visually like a traditional HTML form. The uncorrected OCR data is presented with the best guess proposed value for each field. The proposed value is displayed in a control that appears like a textbox. The image of the source document that was processed by the OCR engine is displayed next to the HTML form.

The system identifies each field in the data generated by the OCR engine as a separate, independent frame. In this fashion, the system is able to highlight individual characters within a field value to visually indicate which characters are low confidence. Additionally, as the user presses the {TAB} or {ENTER} key, the keyboard cursor moves to the next low confidence character whether the character is in the current field or in a different field. This enables users to minimize the overall time spent correcting OCR results by eliminating the need for the user to navigate though high confidence characters that can generally be ignored by the user. As the user tabs to each character, the system zooms in on the appropriate zone in the image of the source document related to the current character or field, making it easy for the user to determine whether the OCR engine produced the correct data or not.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A is a high level overview diagram illustrating an example system for correcting low confidence characters from an OCR engine;

FIG. 1B is a block diagram illustrating an example OCR server system for correcting low confidence characters from an OCR engine;

FIG. 2A is an application screen shot illustrating an example OCR editing interface using entire field editing;

FIG. 2B is an application screen shot illustrating an example OCR editing interface using individual character editing;

FIG. 3 is a flow chart illustrating an example process for facilitating individual character OCR editing;

FIG. 4 is a flow chart illustrating an example process for creating individual fields for a document;

FIG. 5 is a flow chart illustrating an example process facilitating low confidence character editing; and

FIG. 6 is a block diagram illustrating an example computer system that may be used in connection with various embodiments described herein.

### DETAILED DESCRIPTION

Certain embodiments as disclosed herein provide for systems and methods for correcting low confidence characters from an OCR system using an HTML form that does not require an installed application at the operator station. For example, one method as disclosed herein allows for an OCR server system to parse OCR data and create a data structure that is used to create an HTML form that is presented to the operator in a standard web browser. The operator is then able to use the TAB or ENTER key (or some other indicator) to visit only those characters that were identified by the OCR system as having a low confidence value. In this fashion an operator can work much more efficiently.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

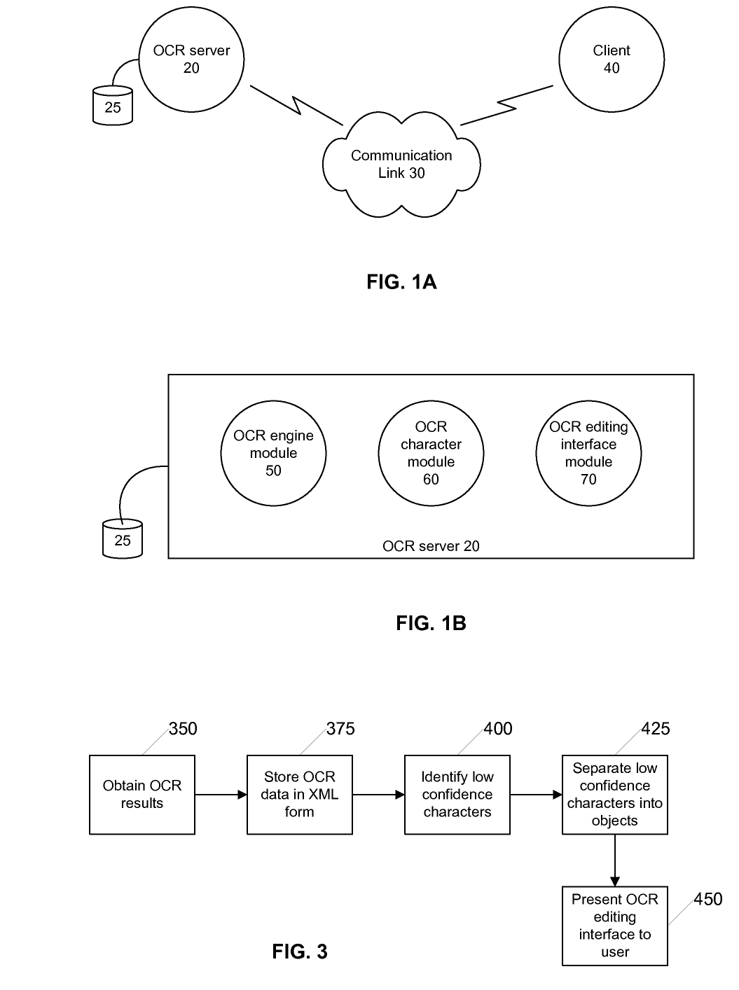

FIG. 1A is a high level overview diagram illustrating an example system for correcting low confidence characters from an OCR engine. In the illustrated embodiment, the system comprises an OCR server 20 configured with a data storage area 25. The OCR server 20 is communicatively coupled with a client 40 via a communication link 30. The communication link 30 may be a network or a direct communication link. As a network, the communication link 30 may be wired or wireless, public or private, or any combination of these including, for example, the Internet. As a direct communication link, the communication link 30 may be a physical cable (e.g., a universal serial bus (“USB”) cable, firewire cable, or the like) or a wireless link (e.g., Bluetooth). The function of the communication link 30 is to facilitate the transfer of data between the OCR server 20 and the client 40. Data may include text, graphics, audio, video, executable instructions, interpretable instructions, and all other information that may be useful for carrying out correction of low confidence characters generated by an OCR engine.

The OCR server 20 is configured to generate raw text data from a native image (image of the source document) and also to estimate a confidence level corresponding to the expected accuracy of the text generated from the native image. The native images and corresponding text can be stored in the data storage area 25.

The client 40 can be any of a variety of client devices running any of a variety of software modules that facilitate the viewing of data generated by the OCR server 20. In one embodiment, the client 40 comprises a standard web browser utility that is capable of displaying HTML data and interpreting JavaScript instructions. One advantage of employing a standard web browser on the client 40 is the ability for any device with such a standard web browser to operate as a thin client in the system for correcting low confidence characters.

FIG. 1B is a block diagram illustrating an example OCR server system 20 for correcting low confidence characters from an OCR engine. In the illustrated embodiment, the OCR server 20 comprises an OCR engine module 50, an OCR character module 60, and an OCR editing interface module 70. The OCR engine module 50 is configured to generate the raw text data from a scanned image. For example, in one embodiment the OCR engine module 50 analyzes an image including text and translates the text portions of the image into raw text data. Additionally, for each translated character the OCR engine module 50 also generates a corresponding confidence level to indicate the expected accuracy of the translated character.

The OCR character module 60 is configured to parse the raw text data generated by the OCR engine module 50 and populate a data structure (not shown) that relates the individual characters in the raw text data with the corresponding confidence levels generated by the OCR engine module 50 and the location of the individual character on the native image that was processed by the OCR engine 50 to generate the raw text data. In one embodiment, the location of the individual character on the native image is determined by X-Y coordinates.

The OCR editing interface module 70 is configured to present the raw text data to an operator (e.g., via the client 40) and allow the operator to step through low confidence characters and correct or validate those characters while simultaneously viewing the corresponding area of the native image that was processed by the OCR engine 50 to generate the raw text data.

In one embodiment, a single computer may host the OCR engine module 50, the OCR character module 60, the OCR editing interface module 70, as well as the data storage area 25 that stores the OCR XML data structure. In another embodiment, the various modules and data storage can be hosted on separate server computers. Alternatively, various combinations of the modules and storage components can be hosted separately or cooperatively on one or two or even more computing platforms.

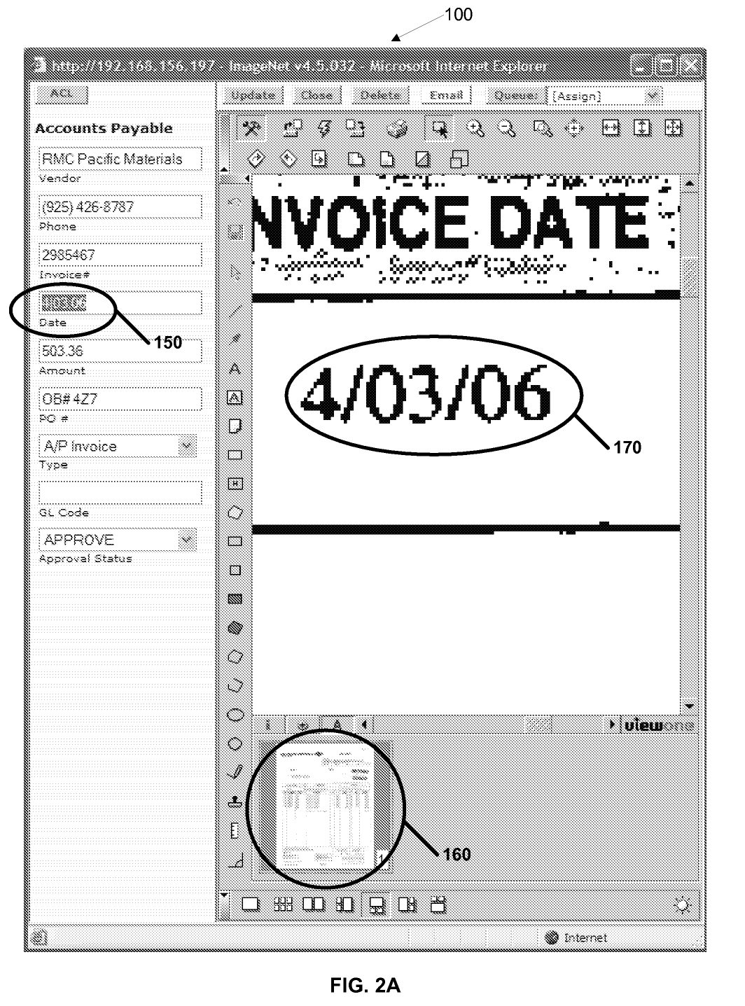

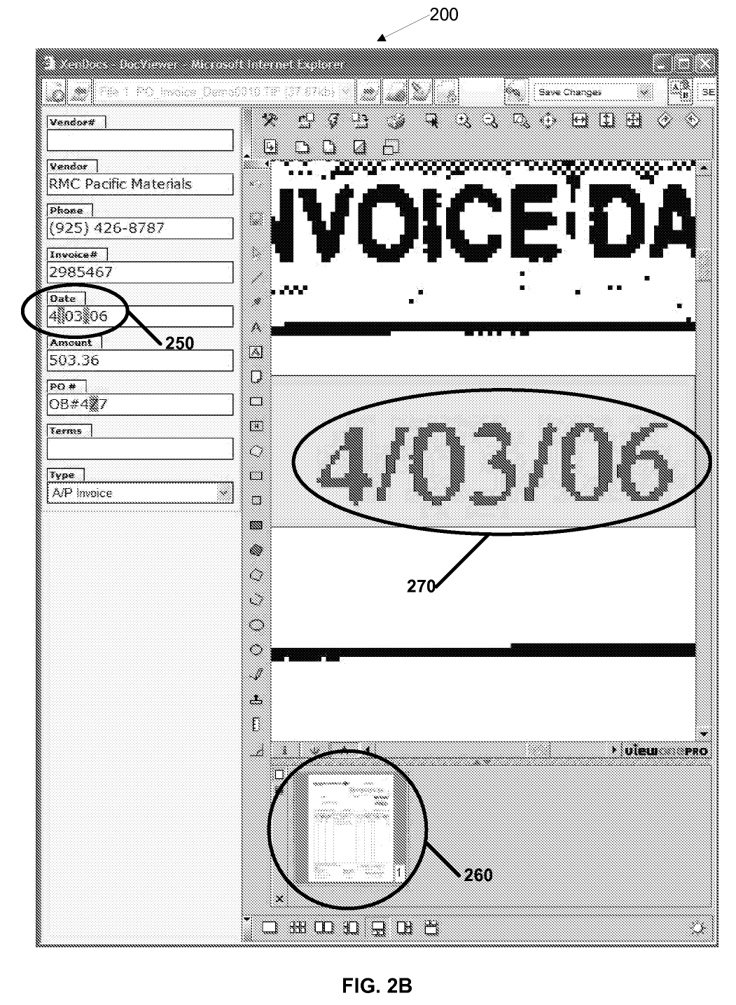

FIG. 2A is an application screen shot illustrating an example OCR editing interface 100 using entire field editing. In the illustrated embodiment, the OCR editing interface 100 comprises a text area that includes translated text including date field 150. The OCR editing interface 100 also comprises an image area for displaying the native image that was processed by the OCR engine 150 to generate the raw text data including the corresponding image of the date 170. The OCR editing interface 100 also comprises a thumbnail 160 of the overall image that was processed by the OCR engine 150 to generate the raw text data.

In the illustrated embodiment, the OCR engine module generated raw text data from a scanned invoice document and the raw text data was populated into various fields such as the date field 150 and other fields including the invoice number, phone number, vendor name, etc. As can be seen, the character string that makes up the date 170 as it appears on the native image is “4/3/06” while the raw text data that was generated by the OCR engine module is “4|03;06” such that the two slash “/” characters in the native image were incorrectly translated as the pipe “|” character and the semi-colon “;” character, respectively. These incorrectly translated characters need to be edited by an operated so that they are corrected.

In one embodiment, the date 150 is presented to an operator as a single field with the character string “4|03;06” in it and the operator is allowed to edit the entire field based on what the operator sees in the date 170 portion of the native image. However, this can be time consuming for an operator to edit the entire field.

FIG. 2B is an application screen shot illustrating an example OCR editing interface 200 using individual character editing. In the illustrated embodiment, the OCR editing interface 200 comprises a text area that includes translated text including date 250. In this embodiment, the date 250 is not just a single field but rather a series of discrete characters in the data structure where each character in the string comprising the date 250 is an individual character object. In one embodiment, the individual character objects in the date 250 field of the OCR editing interface 200 can be created for presentation via a standard web browser interface using an HTML inline frame (“IFrame”) object for the entire field that includes the several individual character objects. An IFrame is an HTML element that allows one HTML document to be embedded inside of another HTML document. Accordingly, each character in the date is a separate field in the data structure with its own confidence level value and location value.

Advantageously, this allows the OCR editing interface 200 to selectively highlight individual characters within the date 150 field or other fields in the OCR editing interface 200. For example, these fields can be highlighted or emphasized with a particular color to indicate the individual characters that have a low confidence level that indicates a possible inaccuracy of the translated character.

A further advantage of presenting each character in a field as a discrete character object is that control in the OCR editing interface 200 can be implemented such that an operator can easily navigate through a series of low confidence characters and make corrections an/or validations on a character by character basis. For example, an operator may use the {TAB} key to move from a first low confidence character to a second low confidence character. Advantageously, when the focus of the OCR editing interface 200 moves from a first low confidence character to a second low confidence character, the corresponding native image portion also moves to the location of the native image where the translated text appears. This combination of individual character editing and simultaneous display of the corresponding native image facilitates rapid correction by an operator.

For example, in the illustrated embodiment, the pipe “|” and semi-colon “;” character in the date 250 field are separately highlighted (as is the capital “Z” character in the purchase order number field). The date 270 portion of the native image shows that the actual character used in the date is the slash “/” character. Because the OCR engine identified the pipe “|” and semi-colon “;” characters as low confidence characters, they are highlighted in the display on the client 40 and the operator can navigate the focus of the OCR editing interface 200 from the pipe “|” character to the semi-colon “;” character (after correction) for example by using the {TAB} key or the {ENTER} key. Similarly, after correcting the semi-colon “;” character the operator can navigate directly to the capital “Z” character by using the {TAB} key or the {ENTER} key. This advantageously skips over all of the higher confidence characters in between and therefore saves the operator a significant amount of time.

FIG. 3 is a flow chart illustrating an example process for facilitating individual character OCR editing. Initially, in step 350 the raw text results from the OCR engine are obtained. These results represent the translation of text portions of a native image into text characters. The results also include a confidence level for each character that was translated by the OCR engine and a location for each character on the native image. Next, in step 375 the results from the OCR engine are processed and stored in a data structure. In one embodiment, the data structure may be an XML form. The data structure associates each translated character with its confidence level and its X-Y location on the native image. Characters that have a confidence level and fall below a predetermined confidence level threshold are identified as having a low confidence level. In one embodiment, the predetermined threshold can be modified.

Once the data structure has been populated with the data from the OCR engine, each character having a low confidence level is identified in the data structure. For example, a flag may be set within the data structure to identify each low confidence character. Alternatively, each character may be associated with a confidence level value and the low confidence threshold value may also be stored in the data structure.

Next, in step 425 the low confidence characters are separated into discrete character objects for display to an operator and in step 450 the OCR editing interface presents the OCR data to an operator with each low confidence character individually highlighted as shown, for example, in the date field 150 of FIG. 2B. The operator is then allowed to navigate through just the low confidence character objects in the OCR editing interface to correct and/or validate each low confidence character while simultaneously viewing the portion of the native image where the low confidence character appears.

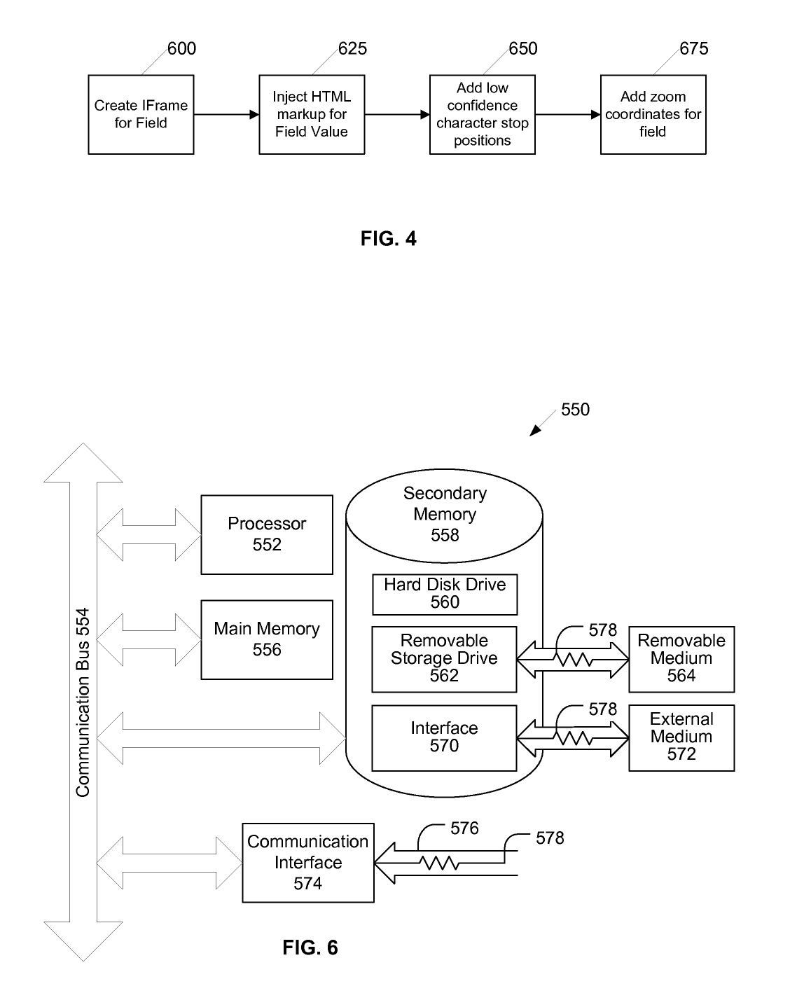

FIG. 4 is a flow chart illustrating an example process for creating individual fields for a document. Initially, in step 600 fields are created using an IFrame for the field box. The HTML document also includes a JavaScript component and the JavaScript stores the information about the field in memory for later use. Also stored is the size of the field and data type. The JavaScript also includes those JavaScript events that make the field interactive.

Next, in step 625 the HTML markup is then injected via JavaScript into the IFrame for each field that represents the value of the field, including any markup to highlight low confidence characters. The low confidence characters are represented by anything that is less than the threshold percentage in confidence, e.g., if the threshold is set to 75% and a character's confidence value is less than 75% it will be highlighted as low confidence via HTML markup. Low confidence characters are also represented in memory by the JavaScript for the different stop positions for navigation. In one embodiment, this is accomplished by a two dimensional array in memory that tracks stop positions for each field and for each stop in each field's position. For example, the date may be a single field that has two stop positions, a first stop position for the first low confidence character (e.g., “|”) and a second stop position for the second low confidence character (e.g., “;”). Next, in step 650 the stop positions are added that are used to find the navigation points when in advanced validation mode.

Then in step 675 the X-Y coordinates are also added to allow zooming in the document to the particular location in the original image of the source document from where the field value was captured. In one embodiment, the X-Y zoom coordinates are stored in a separate two dimensional array in memory that tracks based on field and the region to zoom to for that field.

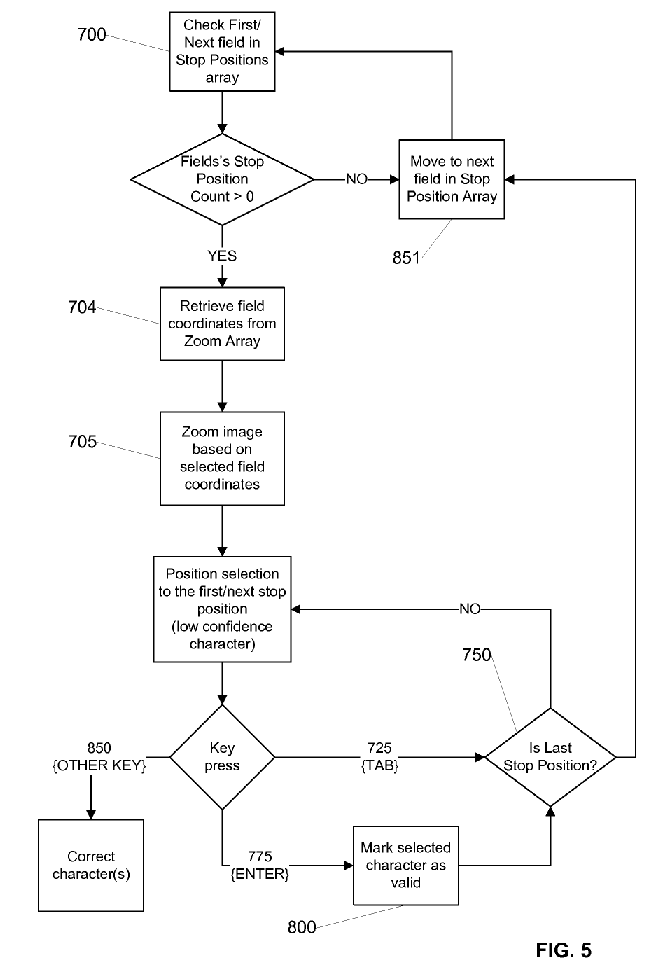

FIG. 5 is a flow chart illustrating an example process facilitating low confidence character editing. Once the fields are defined and rendered the JavaScript then takes over to handle all navigation and interaction with the individual fields. Initially, in step 700 the JavaScript positions the selection (i.e., the cursor/input focus) to the first low confidence character when the document is opened in the viewer. It will also zoom the document into the captured X-Y value from the original document image for this field in step 705. This is done by looking up the field from the zoom array and finding its region to zoom into in step 704. Then if the user presses the {TAB} key 725 the system will select the next low confidence character in that field or in the next field that contains a low confidence character in step 750. It does this by checking the stop position array defined earlier. If another stop position exists in the current field, the system uses that position. If the current field does not have another stop position the system checks the next field in the array to determine if it contains any stop positions in step 851. If the field does not contain any stop positions the system moves to the next field that contains a stop position. Once the system finds the next field with at least one stop position, the system stops on that field and moves to the first stop position within that field. If the user presses the {ENTER} key 775 it will mark the current value in that low confidence position as valid in step 800 and move the selection to the next low confidence character in that field or in the next field that contains a low confidence character in step 750 similar to how the {TAB} key works. The user can also edit the low confidence selection to correct it in step 850 by pressing any other key and then hit {TAB} key 725 to move to the next low confidence character. The JavaScript finds the next low confidence character by referencing the pre-defined stops for the fields stored in memory in the two dimensional array when they were first created on the page.

FIG. 6 is a block diagram illustrating an example computer system 550 that may be used in connection with various embodiments described herein. For example, the computer system 550 may be used in conjunction with an OCR server or client device as previously described with respect to FIG. 1. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578. For example, computer software modules that may be stored in the secondary memory 558 may include: (1) an OCR engine module that generates the raw text data from the scanned image; (2) a form module that parses the raw text data generated by the OCR engine module and populates a data structure that relates individual characters to confidence levels and the corresponding location of the individual character on the native scanned image; and (3) an OCR editing interface module that presents the raw text data to an operator and allows the operator to step through low confidence characters and correct them or validate them while viewing the corresponding area of the native scanned image.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software, also referred to as modules) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described. For example, such computer programs stored in the main memory 556 and/or the secondary memory 558 may include: (1) an OCR engine module that generates the raw text data from the scanned image; (2) a form module that parses the raw text data generated by the OCR engine module and populates a data structure that relates individual characters to confidence levels and the corresponding location of the individual character on the native scanned image; and (3) an OCR editing interface module that presents the raw text data to an operator and allows the operator to step through low confidence characters and correct them or validate them while viewing the corresponding area of the native scanned image.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the various features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A computer implemented method for correcting low confidence characters from an optical character recognition (“OCR”) system, the method comprising:
receiving from an OCR system an image of a source document and corresponding text data generated by the OCR system as a result of an OCR analysis;
parsing the text data to identify a plurality of fields of text data, each field of text data comprising one or more characters of text data;
parsing the text data to identify a confidence value for each character of text data;
parsing the text data to identify an X-Y coordinate value for each field of text data and for each character of text data;
populating a data structure with each field of text data, the X-Y coordinate value for each field of text data, the characters of text data corresponding to each field, the X-Y coordinate value for each character of text data and the confidence value for each character of text data;
determining a low confidence character threshold;
creating a hypertext markup language (“HTML”) form comprising a plurality of individual field objects, wherein each individual field object includes one or more characters and wherein each character having a confidence value below the low confidence character threshold is identified as a stop position in a field object;
displaying to an operator the HTML form;
simultaneously displaying to the operator an image of a portion of the source document image;
moving an input focus on the HTML form to a first stop position in a field object and visually emphasizing in the displayed HTML form the low confidence character corresponding to the first stop position;
zooming the display of the source document image to the X-Y coordinate value associated with the low confidence character at the first stop position;
receiving an input from the operator to move to another object;
moving the input focus on the HTML form to a second stop position in a field object and visually emphasizing in the displayed HTML form the low confidence character corresponding to the second stop position; and
zooming the display of the source document image to the X-Y coordinates associated with the second low-confidence object.

2. The method of claim 1, wherein the first stop position and the second stop position are in the same field object.

3. The method of claim 1, wherein each field object is an inline frame.

4. The method of claim 1, further comprising simultaneously presenting to the operator a thumbnail image of the entire source document image.

5. The method of claim 1, wherein visually emphasizing comprises changing the color of the background for the low confidence character.

6. The method of claim 1, wherein receiving an input from the operator comprises receiving a change to the text character and updating the data structure with the changed text character.

7. The method of claim 1, wherein receiving an input from the operator comprises receiving an indication of a keystroke from the operator comprising one of the TAB or ENTER key.

8. A technical system for correcting low confidence characters generated by an optical character recognition (“OCR”) system, the system comprising:
an OCR character module configured to receive from the OCR system an image of a source document and corresponding text data generated by the OCR system as a result of an OCR analysis, the OCR character module further configured to parse the text data to identify (i) a plurality of fields of text data, each field of text data comprising one or more characters of text data, (ii) a confidence value for each character of text data, and (iii) an X-Y coordinate value for each field of text data and for each character of text data;
wherein the OCR character module populates a data structure with each field of text data, the X-Y coordinate value for each field of text data, the characters of text data corresponding to each field, the X-Y coordinate value for each character of text data and the confidence value for each character of text data;
an OCR editing interface module configured to generate a hypertext markup language (“HTML”) form comprising a plurality of fields, wherein each field comprises one or more individual characters from the data structure and wherein each individual character having a low confidence level is identified as a stop position in the HTML form, the HTML form further comprising a source document image display portion;
wherein the OCR editing interface module is further configured to present the HTML form to an operator wherein an input focus on the HTML form is moved to a first stop position and the corresponding first low confidence character is visually emphasized and an image of the source document at X-Y location associated with first low confidence character is displayed in the source document image display portion and the operator moves through a series of stop positions to validate or correct the low confidence characters generated by the OCR engine.

9. The system of claim 8, further comprising an OCR engine configured to analyze an image of a source document and convert portions of the source document image into a plurality of fields of text data, each field having one or more characters of text data, the OCR engine further configured to identify an X-Y location in the source document image for each field and character of text data and estimate a confidence level for each character of text data.

10. The system of claim 9, wherein the OCR engine is further configured to estimate a confidence level for each field of text data.

11. The system of claim 8, wherein each field on the HTML form is an inline frame.

12. The system of claim 8, wherein a field on the HTML form comprises a plurality of stop positions.

13. The system of claim 8, wherein the OCR editing interface module is further configured to simultaneously present a thumbnail image of the entire source document image.

14. The system of claim 8, wherein the OCR editing interface module is further configured to visually emphasize by changing the color of the background of a low confidence character.

15. The system of claim 8, wherein the OCR editing interface module is further configured to receive an input from the operator indicating an update to a text character and updating the data structure with the changed text character.

16. The method of claim 1, wherein the OCR editing interface module is further configured to receive an input from the operator to change the input focus to the next stop position wherein the received input is one of the TAB or ENTER key.
